(19) United States
(12) Patent Application Publication
(10) Pub. No.: US 2021/0056725 A1
(43) Pub. Date: Feb. 25, 2021

(54) MACHINE VISION SYSTEM AND METHOD

(71) Applicant: Lune Rouge Divertissement Inc., Montréal (CA)

(72) Inventor: Alexandre BARRETTE, Montreal (CA)

(21) Appl. No.: 16/998,632

(22) Filed: Aug. 20, 2020

Related U.S. Application Data
(60) Provisional application No. 62/889,309, filed on Aug. 20, 2019.

(51) Int. Cl. G06T 7/73; G02B 27/01; G06T 1/00; G02B 27/00

(52) U.S. Cl. CPC G06T 7/74; G02B 27/0172; G06T 2207/30244; G02B 27/0093; G06T 2207/10048; G06T 1/0014

(57) ABSTRACT

A system and method for creating a reference frame for use in defining a pose of a machine vision device are provided. A reference frame comprising a unique pattern of infrared features is generated and the pattern is rendered into a viewing location for capture by the machine vision device and for use in determining the pose of the machine vision device relative to the reference frame. The machine vision device is configured to capture one or more images of the viewing location in infrared, detect the pattern in the one or more captured images, and determine the pose in real-time, based on the pattern as detected.

### CROSS-REFERENCE TO RELATED APPLICATIONS

This application claims priority of U.S. application No. 62/889,309 filed on Aug. 20, 2019, the entire contents of which are incorporated by reference herein.

### TECHNICAL FIELD

The present disclosure relates generally to machine vision, and more specifically to creating a reference frame and determining the pose of a machine vision device based on the reference frame.

### BACKGROUND OF THE ART

Currently, machine vision algorithms, such as those used in Augmented Reality (AR) or Virtual Reality (VR) devices, use visible light to correctly define their six-axis (X, Y, Z, Yaw, Pitch and Roll) world position. However, such algorithms do not work in darkness or low light conditions and may malfunction when the visible light landscape changes (e.g., in changing and moving light levels). Furthermore, existing algorithms induce errors when analyzing a homogeneous and/or symmetric environment (e.g., a room with four walls of the same dimensions without differentiating features) in an attempt to define their world position.

Therefore, improvements are needed.

### SUMMARY

In accordance with a broad aspect, there is provided a system for creating a reference frame for use in defining a pose of a machine vision device. The system comprises a processing unit and a non-transitory memory communicatively coupled to the processing unit and comprising computer-readable program instructions executable by the processing unit for generating the reference frame comprising a unique pattern of infrared features, and rendering the pattern into a viewing location for capture by the machine vision device and for use in determining the pose of the machine vision device relative to the reference frame.

In accordance with another broad aspect, there is provided a machine vision system comprising a reference frame creating unit configured to generate a reference frame comprising a unique pattern of infrared features, and render the pattern into a viewing location, and a machine vision device having a pose definable relative to the reference frame, the machine vision device configured to capture one or more images of the viewing location in infrared, detect the pattern in the one or more captured images, and determine the pose in real-time, based on the pattern as detected.

In accordance with yet another broad aspect, there is provided a computer-implemented method for creating a reference frame for use in defining a pose of a machine vision device. The method comprises generating, with a computing device, the reference frame comprising a unique pattern of infrared features, and rendering, with the computing device, the pattern into a viewing location for capture by the machine vision device and for use in determining the pose of the machine vision device relative to the reference frame.

In accordance with yet another broad aspect, there is provided a non-transitory computer readable medium having stored thereon program code executable by at least one processor for generating a reference frame comprising a unique pattern of infrared features, and rendering the pattern into a viewing location for capture by a machine vision device and for use in determining a pose of the machine vision device relative to the reference frame.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a flowchart of a method for generating an infrared reference frame, in accordance with an embodiment;

FIG. 2 is a flowchart of a method for determining a pose of a machine vision device based on the infrared reference frame generated in accordance to the method of FIG. 1, in accordance with an embodiment;

FIG. 3 is a schematic diagram of system for generating an infrared reference frame and determining a pose of a machine vision device based on the infrared reference frame as generated, in accordance with an embodiment;

FIG. 4 is photo showing an infrared reference frame rendered into a viewing location, in accordance with an embodiment;

FIG. 5 is a block diagram of the reference frame creating unit of FIG. 3, in accordance with an embodiment;

FIG. 6 is a block diagram of the machine vision device of FIG. 3, in accordance with an embodiment; and

FIG. 7 is a block diagram of a computing device, in accordance with an embodiment.

It will be noted that throughout the appended drawings, like features are identified by like reference numerals.

### DETAILED DESCRIPTION

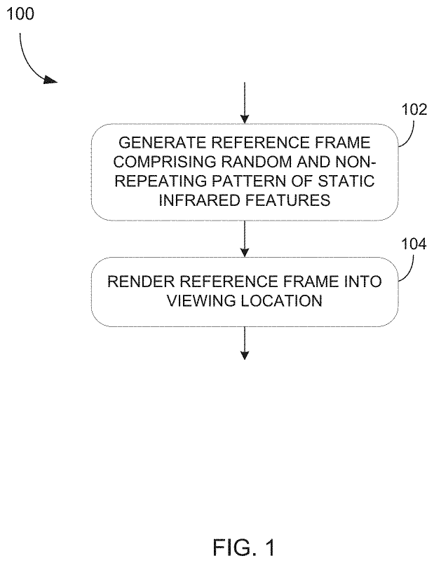

Referring now to FIG. 1, a method 100 for generating an infrared reference frame will now be described, in accordance with one embodiment. The method 100 may be adapted to various machine vision applications. For example, the systems and methods described herein can be adapted for use in AR and VR systems and/or environments. In particular, the systems and methods described herein may be applied for use in environments where a high degree of movement (e.g., user movement) is experienced, such as during a live show occurring at an entertainment venue in front of a crowd of five (5) attendees or more. It should be understood that the systems and methods described herein may also be adapted to other suitable environments.

As will be discussed further below, the method 100 is illustratively used to provide, to a machine vision device, a reference frame that allows the machine vision device to reference itself (i.e. its pose) relative to the reference frame. For this purpose, infrared markers or features are distributed into an area (referred to herein as a “viewing location”) of an environment being analyzed by the machine vision device in order to offer data points for the machine vision algorithm(s) to analyze. The infrared features are disposed in a random and non-repetitive fashion to create a unique infrared topology. The machine vision device may then use an algorithm (referred to herein as a “tracking algorithm”) to reference its pose relative to the reference frame. This may be referred to as a “tracking” process.

Still referring to FIG. 1, the method 100 comprises generating, at step 102, a reference frame comprising a random and non-repeating pattern of static infrared features. The pattern is created using computer simulation. In one embodiment, the positioning of the infrared features is determined by generating a grid pattern and laying the grid pattern over a plurality of randomly positioned virtual objects. The virtual objects may be randomly positioned within a virtual representation of the real-world environment being analyzed (i.e. positioned within a virtual computing environment). The grid pattern is illustratively generated to optimize tracking of the tracking algorithm. A number of variables, including, but not limited to, resolution of a camera and/or sensor of the machine vision device, a user's distance from the grid pattern (i.e. from the viewing location), a type of tracking algorithm (e.g., dense vs sparse tracking), and environmental factors (inside environment being analyzed, outside environment, crowd size) will impact the pattern generation. In particular, the above-mentioned parameters may affect a grid pattern type (e.g., pattern comprising of points, lines or curves), a density of infrared features forming the pattern, feature size, and an overlap of the infrared features. As a result, a unique modified pattern may be obtained and used as the reference frame.

The next step 104 is to render the reference frame into the real-world environment, at the viewing location. In one embodiment, the reference frame may be rendered at step 104 by using an infrared projector to project the reference frame onto an infrared reflective surface provided at the viewing location. In order to project the reference frame at the correct viewing location, the projector may be referenced with respect to the reference frame using any suitable technique. In other words, the inner coordinate system of the projector may be spatially correlated to the reference frame. It should be understood that the infrared projector may be attached to the machine vision device or separate therefrom. It should also be understood that the infrared projector may be stationary or moveable within the real-world environment being analyzed.

In another embodiment, the reference frame may be rendered at step 104 by emitting the reference frame into the viewing location using one or more infrared emitting sources embedded within structural fixture(s), architectural fixture(s), and/or scenic fixture(s) provided at the viewing location, within the real-world environment being analyzed. In yet another embodiment, the reference frame may be rendered at step 104 by using an infrared light source to lay the reference frame upon an infrared transmitting surface (i.e. a surface transmissive to light in the infrared spectrum but opaque to light in the visible spectrum) and accordingly reveal the pattern.

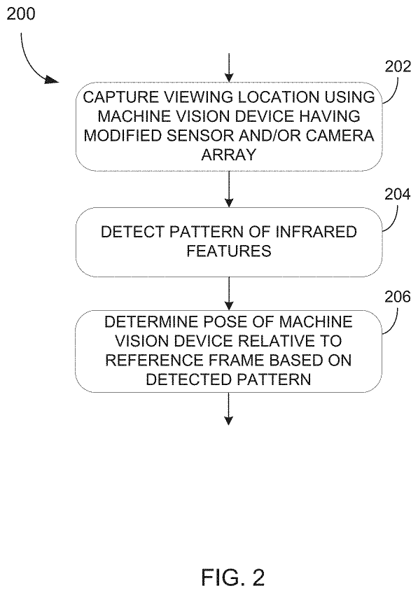

Referring now to FIG. 2, a method 200 (or tracking algorithm) for determining a pose of a machine vision device based on the infrared reference frame generated in accordance to the method 100 of FIG. 1 will now be described, in accordance with one embodiment. As used herein, the term “pose” refers to the position (or direction) and orientation of the machine vision device, the pose comprising at least three translational degrees of freedom and at least one three rotational degrees of freedom. The pose may be expressed in terms of an x-axis position, a y-axis position, a z-axis position, yaw (Y, also referred to as azimuth angle), pitch (P, also referred to as elevation angle), and roll (R, also referred to as rotation), where yaw is the counterclockwise rotation about the z axis, pitch is the counterclockwise rotation about the y axis, and roll is the counterclockwise rotation about the x axis.

The method 200 may be used to determine, in real-time, the pose of (i.e. to track) the machine vision device with respect to a scene that the machine vision device is viewing. In one embodiment, the method 200 may be continually performed to continuously determine the pose of the machine vision device in operation.

The method 200 comprises capturing, at step 202, one or more images of the viewing location using the machine vision device. For this purpose, a sensor array and/or camera array of the machine vision device are illustratively modified beforehand, such that the machine vision device is configured to only “see” in the infrared light spectrum. In particular, the sensor array and/or the camera array are illustratively configured (e.g., using a suitable filter, such as an infrared pass filter) to only allow light within a predetermined infrared wavelength band (corresponding to the infrared wavelength band of the infrared features) to pass and be detected. The machine vision device then captures, within its field of view, one or more images of the viewing location in infrared.

The next step 204 is for the machine vision device to detect the pattern of infrared features based on the captured image(s). This may be achieved using any suitable technique, such as n-View geometry estimation. In one embodiment, Triangulation (e.g., Direct Linear transform or Iterated Least squares), rotation averaging, or translation averaging may be used at step 204.

The machine vision device then determines its pose relative to the reference frame, based on the detected pattern (step 206). This may be achieved based on the known position of the infrared features forming the pattern. For example, the pose of the infrared features may be stored in memory and/or a database or other suitable data storage device after the pattern, and accordingly the reference frame, is generated. The machine vision device may then be configured to query the storage device to correlate each captured infrared feature, as detected at step 204, with the stored pose of infrared features. The machine vision device may then determine its pose based on the result of the correlation. Other embodiments may apply.

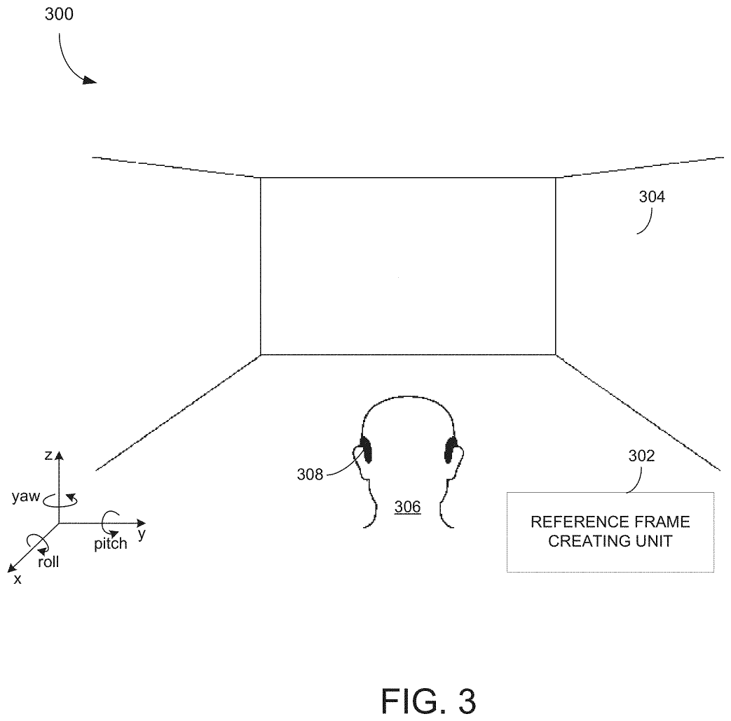

FIG. 3 illustrates a system 300 that may be used for generating the infrared reference frame described above and determining the pose of a machine vision device based on the infrared reference frame as generated, in accordance with an embodiment.

The system 300 comprises a reference frame creating unit 302, which is configured to generate and render, into a viewing location 304 of a given three-dimensional non-virtual (i.e. physical or real-world) environment being analyzed, the infrared reference frame discussed above. The viewing location is viewed by a user 306, using a machine vision device 308. In one embodiment, the machine vision device 308 may be an augmented-reality (AR) device. In one embodiment, the machine vision device 308 is an AR device that can be worn on a head, or part of the head, of the user 306. It should be understood that other embodiments may apply. For example, in some embodiments, the machine vision device 308 may be a handled device, such as a smartphone or a tablet.

The machine vision device 308 includes a display (not shown) which can superimpose virtual elements over the field of view of the user 306. In the embodiment illustrated in FIG. 3, the machine vision device 308 comprises wearable AR glasses or goggles configured to present an AR environment, e.g. via a suitable display (not shown) viewable by the user 306. It should however be understood that other suitable AR devices including, but not limited to, a head worn display (HWD), a helmet mounted display (HMD), an AR headset, and AR visor, AR contact lenses, or the like, may apply. It should also be understood that the machine vision device 308 may comprise any device or object, other than an AR device, requiring accurate six degrees of freedom in real-time.

The system 300 is illustratively used to allow the machine vision device to accurately determine its six-axis pose (i.e. direction and orientation) in real-time. As known to those skilled in the art and as previously described, the pose comprises at least three translational degrees of freedom and at least three rotational degrees of freedom. In the embodiment illustrated in FIG. 3, the pose is expressed in an (x, y, z, Y, P, R) coordinate system, with the three-dimensional (3D) rotation of the machine vision device being, for instance, expressed in terms of YPR angular coordinates. It should however be understood that angular coordinate systems other than YPR may apply.

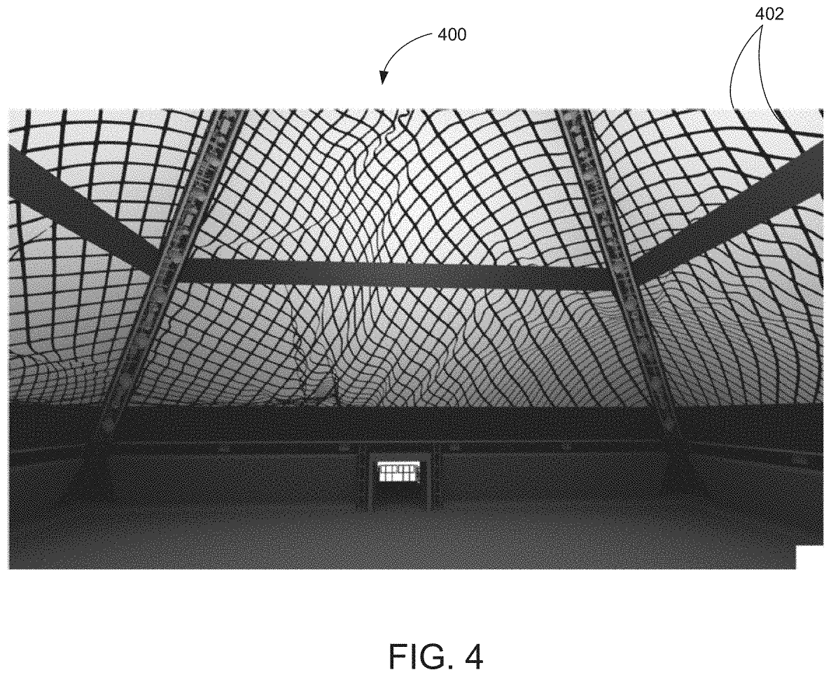

FIG. 4 shows an illustrative infrared reference frame 400 as generated by the reference frame creating unit 302 and rendered into the viewing location 304 of FIG. 2, in accordance with one embodiment. It can be seen from FIG. 4 that the reference frame 400 comprises a unique grid-like pattern of infrared features (illustrated as lines 402 in FIG. 4).

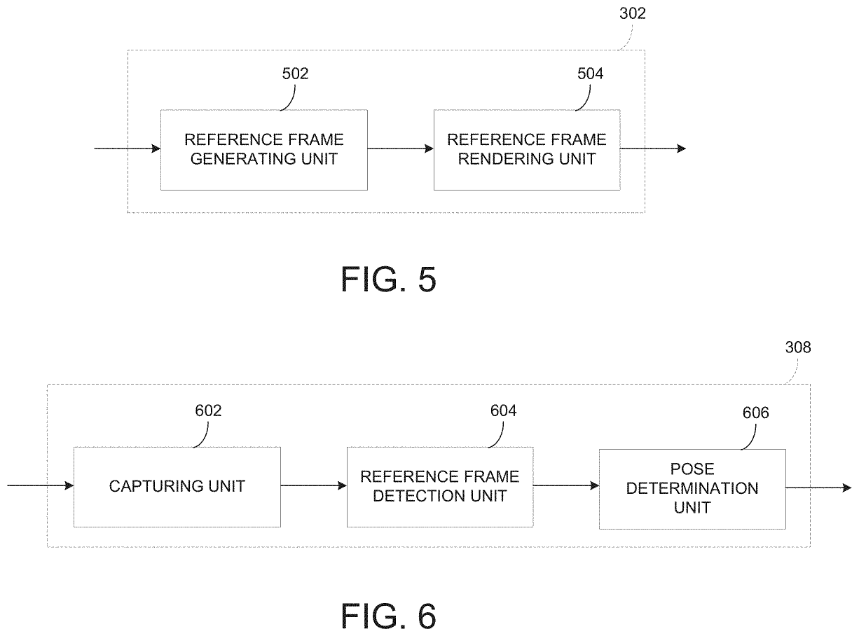

Referring now to FIG. 5, the reference frame creating unit 302 illustratively comprises a reference frame generating unit 502 and a reference frame rendering unit 504. The reference frame generating unit 502 is illustratively configured to generate the random and non-repeating pattern of infrared features. For this purpose, the reference frame generating unit 502 may be configured to generate the pattern of infrared features using any suitable technique including, but not limited to, using a pseudo-random code, a Quick Response (QR) code, an ArUco code, and Aztec code, and the like. The positioning of the infrared features may be set such that the machine vision device (reference 308 in FIG. 3) captures, at least most of the time, the infrared features within its field of view.

In some embodiments, the generated pattern of infrared features is stored within the reference frame generating unit 502, or within a memory or other data repository (none shown) connected thereto. The reference frame rendering unit 504 is then configured to render the pattern generated by the reference frame generating unit 502 into the viewing location. In some embodiments, the pattern may be rendered into the viewing location in response to an input received from the user (reference 306 in FIG. 3). In some other embodiments, the pattern may be rendered into the viewing location in response to an external trigger. In some further embodiments, the pattern can be rendered into the viewing location based on a timer. Other approaches are also considered.

In one embodiment, the reference frame rendering unit 504 may comprise one or more controllers for controlling the operation of an infrared projector. The infrared projector may be controlled to project the reference frame onto an infrared reflective surface provided at the viewing location. In another embodiment, the reference frame rendering unit 504 may comprise one or more controllers for controlling the operation of one or more infrared emitting sources embedded within structural fixture(s), architectural fixture(s), and/or scenic fixture(s) provided at the viewing location. In this manner, the infrared emitting source(s) can be controlled to emit the reference frame into the viewing location. In yet another embodiment, the reference frame rendering unit 504 may comprise one or more controllers for controlling the operation of an infrared light source such that the pattern is laid upon an infrared transmitting surface provided at the viewing location. The infrared pattern would then be revealed accordingly.

Referring now to FIG. 6, the machine vision device 308 illustratively comprises a capturing unit 602, a reference frame detection unit 604, and a pose determination unit 606. The capturing unit 602 is configured to capture one or more images of the viewing location into which the reference frame has been rendered. For this purpose, the capturing unit 602 (which may comprise a sensor array and/or a camera array) is illustratively configured so as to only visually capture the environment in the infrared and/or near-infrared range (i.e. only “see” the infrared light spectrum). The capturing unit 602 may comprise any suitable devices including, but not limited to, one or more cameras (e.g., infrared, near-infrared, panoramic, and/or depth cameras), scanners, and the like. In some embodiments, the one or more images of the viewing location are acquired by the capturing unit 602 based on input from the user (reference 306 in FIG. 3). In other embodiments, the one or more image(s) are automatically acquired by the capturing unit 602 based on one or more triggers. In some further embodiments, the one or more image(s) are acquired by the capturing unit 602 based on a combination of user input and trigger(s).

The reference frame detection unit 604 is then configured to detect the reference frame (i.e. the pattern of infrared features) within the captured image(s), as discussed above with reference to FIG. 2. The pose determination unit 606 is then configured to determine the pose of the machine vision device 308 relative to the reference frame, based on the infrared pattern as detected.

FIG. 6 illustrates an embodiment where the machine vision device 308 is self-contained, such that the machine vison device 308 comprises the capturing unit 602, the reference frame detection unit 604, and the pose determination unit 606, and accordingly has stored therein the instructions for capturing the image(s) of the viewing location, detecting the reference frame within the captured image(s), and determining the pose of the machine vision device 308 relative to the reference frame. It should however be understood that, in another embodiment, the capturing unit 602, the reference frame detection unit 604, and the pose determination unit 606 may be part of a remote computing system (not shown) configured to control the machine vision device 308 and coupled thereto via any suitable wired or wireless means. In this case, the computing system would store thereon the instructions for capturing the image(s) of the viewing location, detecting the reference frame within the captured image(s), and determining the pose of the machine vision device 308 relative to the reference frame.

In one embodiment, the machine vision device 308 further comprises a pose sensor (not shown), configured to provide pose data to support the pose determination performed by the pose determination unit 606. Examples of the pose sensor include, but are not limited to, a gyroscope, a magnometer, an accelerometer, a Global Navigation Satellite System (GNSS) sensor, and an Inertial Measuring Unit (IMU).

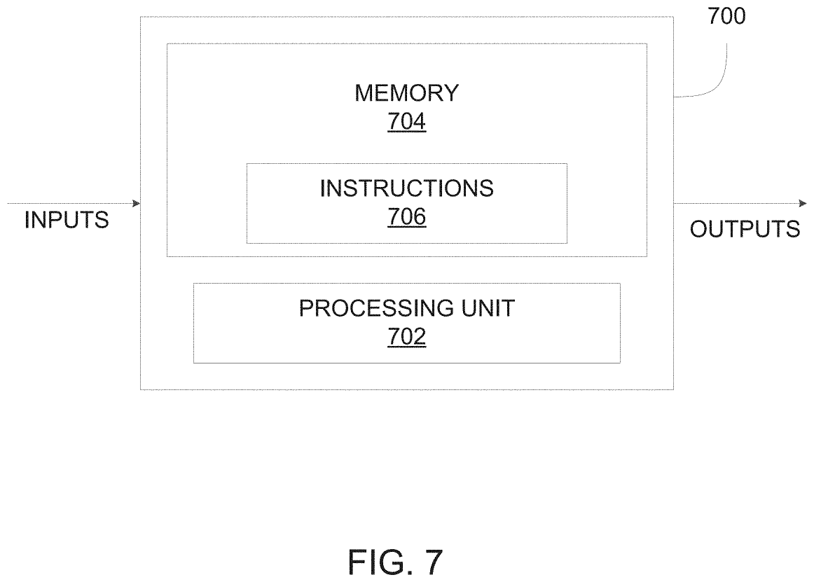

FIG. 7 is an example embodiment of a computing device 700 that may be used for implementing the method 100 described above with reference to FIG. 1, the method 200 described above with reference to FIG. 2, the reference frame creating unit 302 described above with reference to FIG. 5, and at least part of the machine vision device 308 described above with reference to FIG. 6. The computing device 700 comprises a processing unit 702 and a memory 704 which has stored therein computer-executable instructions 706. The processing unit 702 may comprise any suitable devices configured to cause a series of steps to be performed such that instructions 706, when executed by the computing device 700 or other programmable apparatus, may cause the functions/acts/steps specified in the method(s) described herein to be executed. The processing unit 702 may comprise, for example, any type of general-purpose microprocessor or microcontroller, a digital signal processing (DSP) processor, a Central Processing Unit (CPU), a Graphic Processing Unit (GPU), a Holographic Processing Unit (HPU), an integrated circuit, a field programmable gate array (FPGA), a reconfigurable processor, other suitably programmed or programmable logic circuits, or any combination thereof.

The memory 704 may comprise any suitable known or other machine-readable storage medium. The memory 704 may comprise non-transitory computer readable storage medium, for example, but not limited to, an electronic, magnetic, optical, electromagnetic, infrared, or semiconductor system, apparatus, or device, or any suitable combination of the foregoing. The memory 704 may include a suitable combination of any type of computer memory that is located either internally or externally to device, for example random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like. Memory 704 may comprise any storage means (e.g., devices) suitable for retrievably storing machine-readable instructions 706 executable by processing unit 702.

In one embodiment, because the infrared light spectrum is a light range invisible to human vision, using the systems and methods described herein may allow for hiding features (i.e. infrared features imperceptible to the human eye) within an environment without changing the underlying structural, architectural, and/or scenic structure of the environment. In one embodiment the systems and methods described herein may also allow for an area to be bright as day under the infrared light spectrum while the area is in complete darkness under the visible light spectrum. In one embodiment, the systems and methods described herein may prove reliable and stable under various circumstances. For example, machine vision devices may be able to accurately determine their pose in darkness, low light conditions, when the visible light landscape changes, or when the environment being analyzed is homogeneous or symmetric. Moreover, because certain lighting fixtures and projectors do not usually emit in the infrared spectrum, the systems and methods described herein may allow to minimize the noise associated with the reference frame that is rendered within the environment.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, and/or on a computer readable medium. The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A system for creating a reference frame for use in defining a pose of a machine vision device, the system comprising:
a processing unit; and
a non-transitory memory communicatively coupled to the processing unit and comprising computer-readable program instructions executable by the processing unit for:
generating the reference frame comprising a unique pattern of infrared features, and
rendering the pattern into a viewing location for capture by the machine vision device and for use in determining the pose of the machine vision device relative to the reference frame.

2. The system of claim 1, wherein the instructions are executable by the processing unit for generating the reference frame, with the pattern being random and non-repeating and the infrared features being static.

3. The system of claim 1, wherein the instructions are executable by the processing unit for generating the reference frame, with the infrared features having at least one of a predetermined type, density, size, and overlap.

4. The system of claim 1, wherein the instructions are executable by the processing unit for generating the reference frame, with the infrared features comprising at least one of a plurality of points, a plurality of lines, and a plurality of curves.

5. The system of claim 1, wherein the instructions are executable by the processing unit for generating the reference frame comprising generating a grid pattern, laying the grid pattern over a plurality of virtual objects positioned randomly within a virtual representation of the viewing location, thereby obtaining a modified pattern, and using the modified pattern as the reference frame.

6. The system of claim 5, wherein the instructions are executable by the processing unit for generating the grid pattern based on at least one of a resolution of the machine vision device, a user distance from the viewing location, a tracking algorithm used to determine the pose of the machine vision device relative to the reference frame, and one or more environmental factors.

7. The system of claim 1, wherein the instructions are executable by the processing unit for rendering the reference frame comprising causing an infrared projector to project the reference frame onto an infrared reflective surface provided at the viewing location.

8. The system of claim 1, wherein the instructions are executable by the processing unit for rendering the reference frame comprising causing at least one infrared emitting source to emit the reference frame into the viewing location, the at least one infrared emitting source embedded within at least one of a structural fixture, an architectural fixture, and a scenic fixture provided at the viewing location.

9. The system of claim 1, wherein the instructions are executable by the processing unit for rendering the reference frame comprising causing an infrared light source to lay the pattern upon an infrared transmitting surface provided at the viewing location, and accordingly reveal the pattern.

10. The system of claim 1, wherein the instructions are executable by the processing unit for rendering the reference frame into the viewing location for capture by the machine vision device having at least one of a modified sensor array and a modified camera array configured to perceive the infrared light spectrum.

11. The system of claim 10, wherein the machine vision device comprises an infrared pass filter configured to only allow detection of light within a predetermined infrared wavelength band corresponding to a wavelength band of the infrared features.

12. The system of claim 1, wherein the pose of the machine vision device comprises a direction having at least three translational degrees of freedom and a position having at least three rotational degrees of freedom.

13. The system of claim 1, wherein the machine vision device is an augmented-reality device.

14. A machine vision system comprising:
a reference frame creating unit configured to generate a reference frame comprising a unique pattern of infrared features, and render the pattern into a viewing location; and
a machine vision device having a pose definable relative to the reference frame, the machine vision device configured to capture one or more images of the viewing location in infrared, detect the pattern in the one or more captured images, and determine the pose in real-time, based on the pattern as detected.

15. A computer-implemented method for creating a reference frame for use in defining a pose of a machine vision device, the method comprising:
generating, with a computing device, the reference frame comprising a unique pattern of infrared features, and
rendering, with the computing device, the pattern into a viewing location for capture by the machine vision device and for use in determining the pose of the machine vision device relative to the reference frame.

16. The method of claim 15, wherein the reference frame is generated with the pattern being random and non-repeating and the infrared features being static.

17. The method of claim 15, wherein the reference frame is generated with the infrared features having at least one of a predetermined type, density, size, and overlap.

18. The method of claim 15, wherein the reference frame is generated with the infrared features comprising at least one of a plurality of points, a plurality of lines, and a plurality of curves.

19. The method of claim 15, wherein generating the reference frame comprises generating a grid pattern, laying the grid pattern over a plurality of virtual objects positioned randomly within a virtual representation of the viewing location for obtaining a modified pattern, and using the modified pattern as the reference frame.

20. The method of claim 15, wherein rendering the reference frame comprises one of:
causing an infrared projector to project the reference frame onto an infrared reflective surface provided at the viewing location,
causing at least one infrared emitting source to emit the reference frame into the viewing location, the at least one infrared emitting source embedded within at least one of a structural fixture, an architectural fixture, and a scenic fixture provided at the viewing location, and
causing an infrared light source to lay the pattern upon an infrared transmitting surface provided at the viewing location, and accordingly reveal the pattern.

21. A non-transitory computer readable medium having stored thereon program code executable by at least one processor for:
generating a reference frame comprising a unique pattern of infrared features, and
rendering the pattern into a viewing location for capture by a machine vision device and for use in determining a pose of the machine vision device relative to the reference frame.
